(19) United States
(12) Patent Application Publication
(10) Pub. No.: US 2010/0103090 A1
(43) Pub. Date: Apr. 29, 2010

(54) LIQUID CRYSTAL DISPLAY MODULE AND DISPLAY SYSTEM INCLUDING THE SAME

(75) Inventor: Jong-Hak BAEK, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/604,535

(22) Filed: Oct. 23, 2009

(30) Foreign Application Priority Data
Oct. 23, 2008 (KR) 10-2008-0104120

(51) Int. Cl. G09G 3/36

(52) U.S. Cl. 345/102

(57) ABSTRACT

A liquid crystal display (LCD) module includes a flexible backlight unit panel. The LCD module includes an LCD panel and the flexible back light unit panel. The flexible back light unit located behind of the LCD panel includes a plurality of planar light sources that are arranged in a matrix form to provide backlight to the LCD panel. The LCD module does not require diffusion sheet for distributing light sources, has a simple structure and is implemented as a small size, and may effectively perform a local dimming operation.

### CROSS-REFERENCE TO RELATED APPLICATIONS

This application claims priority under 35 USC §119 to Korean Patent Application No. 2008-0104120, filed on Oct. 23, 2008 in the Korean Intellectual Property Office (KIPO), the disclosure of which is incorporated herein in its entirety by reference.

### BACKGROUND

1. Field of the Invention

Example embodiments relate to a display module and more particularly a liquid crystal display (LCD) module using a back light unit (BLU) and a display system including the LCD module.

2. Description of the Related Art

Display devices become more important as media for transferring visual information, and various kinds of flat panel display devices have been developed.

The flat panel display devices include liquid crystal displays (LCD), field emission displays (FED), plasma display panel (PDP) devices, electro-luminescence (EL) devices, and so on.

The LCD module is widely used due to its light weight, thinness, and low power consumption. The LCD module may be used in portable computers such as notebooks, office automation devices, audio/video devices, indoor/outdoor commercial display devices, and so on. A recent improvement of manufacturing technique provides high-resolution and large-sized LCD module.

Liquid cells in the LCD module adjust a light transmittance to display an image according to video signals. The LCD module may include an LCD panel, a back light unit to provide backlight to the LCD panel, and circuits to drive the LCD panel. The LCD panel may include two glass substrates and liquid cells located between the two glass substrates. The liquid cells are arranged in a matrix form and display the image.

The driving circuit in the LCD module sequentially provides gate driving signals to gate lines in the LCD panel, and provides analog image data to data lines to be synchronized with the gate driving signals.

A local dimming technique has been developed to enhance the contrast ratio of the LCD module and reduce the power consumption. A global dimming technique is associated with controlling backlight for a whole frame whereas the local dimming technique is associated with controlling backlight for a portion of a frame according to image data.

A back light unit conventionally includes a spot light source such as a light emitting diode (LED), and thus the back light unit is required to use a diffusion sheet and a prism sheet to convert the spot light source to a planar light source, or a light source that is even across the whole back light unit. When back light unit is implemented with the spot light source, switches for controlling respective blocks of the back light unit and an FPGA (Flexible Programmable Gate Array) may be needed. As the number of blocks increases to enhance the local dimming features, manufacturing costs increase significantly.

### SUMMARY

Example embodiments provide a liquid crystal display (LCD) module for efficiently performing a local dimming operation.

Example embodiments provide a display system including the LCD module.

Additional aspects and utilities of the present general inventive concept will be set forth in part in the description which follows and, in part, will be obvious from the description, or may be learned by practice of the general inventive concept.

Features and/or utilities of the present general inventive concept may be realized by an LCD module including an LCD panel and a flexible backlight unit (BLU) panel.

The flexible back light unit panel may be located behind the LCD panel and may include a plurality of planar light sources arranged in a matrix form to provide backlight to the LCD panel.

The LCD module may further include a back light unit driving circuit and an LCD driving circuit.

The back light unit driving circuit may generate first gate control signals and first source signals based on first image data and a first control signal. The back light unit driving circuit may also drive the flexible back light unit panel based on the first gate control signals and the first source signals. The LCD driving circuit may generate second gate control signals and second source signals based on second image data and a second control signal. The LCD driving circuit drives the LCD panel based on the second gate control signals and the source signals.

The back light unit driving circuit may be included in the flexible back light unit panel, so that the back light unit driving circuit and the flexible back light unit panel may be embodied as one unit. The LCD driving circuit may be included in the LCD panel, so that the LCD driving circuit and the LCD panel may be embodied as one unit.

The LCD module may include a control circuit. The control circuit may receive image data and may generate first image data, a first control signal, second image data, and a second control signal based on the received image data.

The control circuit may include an interface circuit, a storage unit, and a signal processing unit.

The interface circuit generates control signal based on the image data and buffers the image data. The storage unit stores the control signal and the buffered image data, and outputs first and second control signals based on the control signal.

The signal processing unit generates the first image data, the first control signal, the second image data, and the second control signal based on the first control signal and the second control signal.

The storage unit may include a control register and a frame buffer.

The control register stores the control signal, and outputs the first and second control signals based on the control signal. The frame buffer stores the buffered image data.

The signal processing unit may include a back light unit image processor and display image processor.

The back light unit image processor performs a signal processing on the buffered image data to generate the first image data, and outputs the first control signal. The display image processor performs a signal processing on the buffered image data to generate the second image data, and outputs the second control signal.

The back light unit image processor may include an image feature extraction unit, an image classification unit, and a calculation unit.

The image feature extraction unit extracts image features based on the buffered image data, and the image classification unit classifies the image data based on the extracted image features output from the image feature extraction unit. The calculation unit calculates a contrast value and a power supply control value based on the classified image output from the image classification unit to generate the first image data.

The LCD module may further include a power supply unit. The power supply unit may adjust a magnitude of a power supply voltage based on a power control signal from the control circuit to provide the adjusted power supply voltage to the LCD panel and the flexible back light unit panel.

Features and/or utilities of the present general inventive concept may also be realized by a display system including a host and an LCD module.

The host provides image data to the LCD module. The LCD module receives image data from the host, generates first image data, a first control signal, second image data, and a second control signal based on the received image data, drives a flexible back light unit panel based on the first image data and the first control signal, and drives an LCD panel based on the second image data and the second control signal.

The LCD module may include a flexible panel having planar light sources arranged in the matrix form, and thus the LCD module does not need to include a diffusion sheet to diffuse the light sources. Therefore, the LCD module may have a simple structure and may be implemented in a small size. The LCD module may effectively perform the local dimming operation by using the flexible panel as the back light unit.

Features and/or utilities of the present general inventive concept may also be realized by an LCD module including an LCD layer and a backlight layer adjacent to the LCD layer, the backlight layer comprising a plurality of planar light elements to diffusely emit light toward the LCD layer.

The LCD layer may include a plurality of liquid cells arranged in a grid, and the plurality of planar light elements of the backlight layer may be arranged in a grid to correspond to the grid of the LCD layer.

The plurality of planar light elements may be formed on a flexible plastic substrate.

Each of the plurality of planar light elements may include at least one first transistor, at least one capacitor having a first end connected to a drain of the first transistor, at least a second transistor having a gate connected to the drain of the first transistor and a source connected to a second end of the capacitor, and at least one diode connected to the drain of the second transistor.

The backlight layer may further include a plurality of column electrodes, each column electrode of the plurality of column electrodes connected to a source of the first electrode of a plurality of planar backlight elements arranged in a column, and a plurality of row electrodes orthogonal to the plurality of column electrodes, each row electrode of the plurality of row electrodes connected to a gate of the first transistor of a plurality of planar backlight elements arranged in a row.

The LCD module may further include a backlight unit driving circuit to transmit control signals to the plurality of column electrodes and the plurality of row electrodes, respectively.

The backlight unit driving circuit may be located on the backlight unit layer.

The LCD module may further include an LCD driving circuit to drive the LCD layer and a controller to receive an image signal and to output a first image data signal and a first control signal to the backlight unit driver circuit and to output a second image data signal and a second control signal to the LCD driving circuit.

The controller may include an interface circuit to receive the image signal and to output an interface circuit control signal and the image signal, a control register to receive the interface circuit control signal and to output a first control signal to control operation of the backlight layer and a second control signal to control operation of the LCD layer, a frame memory to buffer the image signal, a backlight unit image processor to receive the first control signal and the buffered image signal, to process the buffered image signal, and to output first image data and the first control signal to control the backlight layer, and a display image processor to receive the second control signal and the buffered image signal, to process the buffered image signal, and to output second image data and the second control signal to control the LCD layer.

The backlight unit processor may include an image feature extraction unit to receive the buffered image signal, to extract at least one feature from the image signal, and to output an extracted image feature signal, an image classification unit to receive the extracted image feature signal, to classify the image according to the extracted image feature signal, and to output a classification signal, and a calculation unit to calculate characteristics of the classification signal and to output the second image data.

Features and/or utilities of the present general inventive concept may also be realized by a display system including a host and an LCD module. The host may output an image signal, and the LCD module may receive and display the image signal. The LCD module may include an LCD layer, a backlight layer adjacent to the LCD layer, the backlight layer comprising a plurality of planar light elements to diffusely emit light toward the LCD layer, and a controller to control operation of the LCD layer and the backlight layer. The controller may receive the image signal and control operation of the LCD layer and the backlight layer according to the received image signal.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a block diagram illustrating a liquid crystal display (LCD) module according to some example embodiments.

FIG. 2 is a block diagram illustrating an example of the control circuit included in the LCD module of FIG. 1;

FIG. 3 is a block diagram illustrating an example of a backlight unit (back light unit) image processor included in the control circuit of FIG. 2;

FIG. 4 is a block diagram illustrating an example of a back light unit driving circuit included in the LCD module of FIG. 1;

FIG. 5 is a block diagram illustrating an example of an LCD driving circuit included in the LCD module of FIG. 1;

FIG. 6 is a flow chart illustrating a method of driving the LCD module according to an embodiment of the present general inventive concept;

FIG. 7 is a flowchart illustrating an example of generating the first image data in FIG. 6;

FIG. 8 illustrates an LCD panel and a flexible back light unit panel having a plurality of planar light sources in the matrix form;

FIG. 9 is a circuit diagram illustrating an example of a cell array of the flexible back light unit panel;

FIG. 10 illustrates waveforms of the control signals applied to the row electrodes and the column electrodes of the cell array in FIG. 9;

FIG. 11 is a diagram illustrating the flexible back light unit panel divided into a plurality of blocks for the local dimming operation;

FIG. 12 is a block diagram illustrating an LCD module according to some example embodiments;

FIG. 13 is a block diagram illustrating a display system including the LCD module according to some example embodiments; and

FIG. 14 is an expanded view of layers of the LCD unit.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. The inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

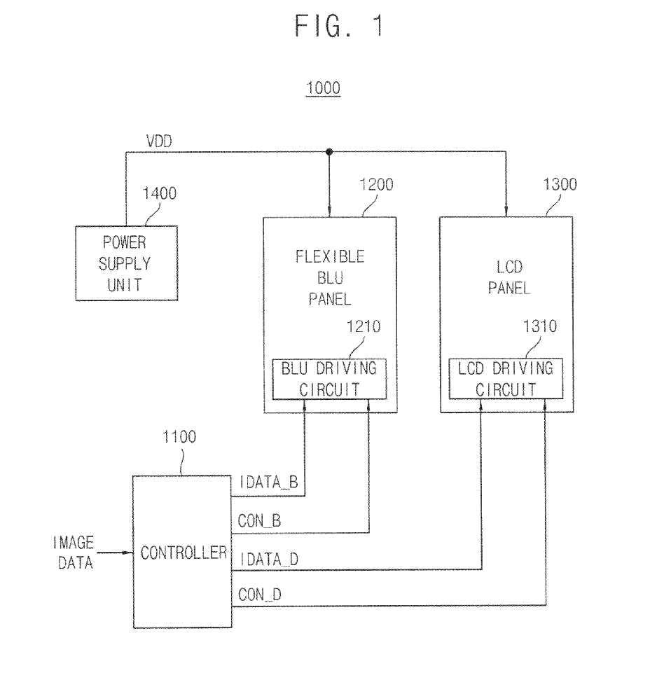

FIG. 1 is a block diagram illustrating a liquid crystal display (LCD) module according to an embodiment of the present general inventive concept.

Referring to FIG. 1, an LCD module 1000 may include a control circuit 1100, a flexible backlight unit (back light unit) panel 1200, and an LCD panel 1300.

The control circuit 1100 receives image data IMAGE DATA from an external device, and generates first image data IDATA_B, a first control signal CON_B, second image data IDATA_D, and a second control signal CON_D. The external device may be any device that generates a video signal to drive a display device, including commercial video devices, broadcast video signals, computer-generated video signals, or any other video device.

The flexible back light unit panel 1200 is located behind the LCD panel 1300. The flexible back light unit panel 1200 includes a plurality of planar light sources that are arranged and driven in a matrix form to provide backlight to the LCD panel 1300, as will be described later.

The LCD module 1000 may include a back light unit driving circuit 1210 and a LCD driving circuit 1310. The back light unit driving circuit 1210 is included in the flexible back light unit panel 1200, so that the back light unit driving circuit 1210 and the flexible back light unit panel 1200 are embodied as one unit. The LCD panel driving circuit 1310 is included in the LCD panel 1300, so that the LCD panel driving circuit 1310 and the LCD panel 1300 are embodied as one unit. For example, the back light unit driving circuit 1210 and the LCD panel driving circuit 1310 may be implemented with a semiconductor integrated circuit, and the back light unit driving circuit 1210 may be mounted on the flexible back light unit panel 1200 and the LCD panel driving circuit 1310 may be mounted on the LCD panel 1300.

The back light unit driving circuit 1210 generates first gate control signals and first source signals based on the first image data IDATA_B and the first control signal CON_B. The first image data IDATA_B is required for driving data lines of the flexible back light unit panel 1200 and the first control signal CON_B is required for controlling operation timing of the flexible back light unit panel 1200. The back light unit driving circuit 1210 drives the flexible back light unit panel 1200 based on the first gate control signals and the first source signals.

The LCD panel driving circuit 1310 generates second gate control signal and second source signals based on the second image data IDATA_D and the second control signal CON_D. The second image data IDATA_D is required for driving data lines of the LCD panel 1300 and the second control signal CON_D is required for controlling operation timing of the LCD panel 1300. The LCD panel driving circuit 1310 drives the LCD panel 1300 based on the second gate control signals and the second source signals.

The LCD module 1000 may further include a power supply unit 1400 providing a power supply voltage VDD to the flexible back light unit panel 1200 and the LCD panel 1300.

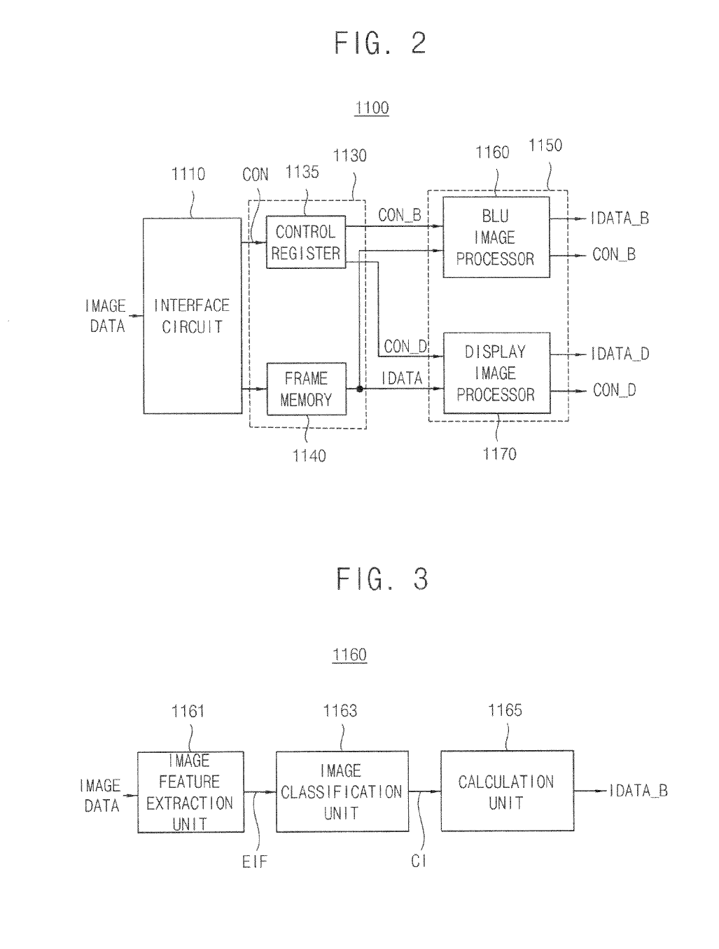

FIG. 2 is a block diagram illustrating an example of the control circuit included in the LCD module of FIG. 1.

Referring to FIG. 2, a control circuit 1100 may include an interface circuit 1110, a storage unit 1130, and a signal processing unit 1150.

The interface circuit 1110 receives the image data from an external device such as a host and generates a control signal CON based on the received image data. The storage unit 1130 stores the control signal CON and buffers the received image data, and outputs the first control signal CON_B and the second control signal CON_D based on the control signal CON.

The signal processing unit 1150 generates the first image data IDATA_B, the first control signal CON_B, the second image data IDATA_D, and the second control signal CON_D based on the buffered image data IDATA, the first control signal CON_B, and the second control signal CON_D.

The storage unit 1130 may include a control register 1135 and a frame buffer 1140. The control register 1135 stores the control signal CON, and outputs the first control signal CON_B and the second control signal CON_D based on the control signal CON. The frame buffer 1140 buffers the received image data and output the buffered image data IDATA.

The signal processing unit 1150 may include a back light unit image processor 1160 and a display image processor 1170.

The back light unit image processor 1160 performs a signal processing on the buffered image data IDATA to generate the first image data IDATA_B, and outputs the first control signal CON_B. The display image processor 1170 performs a signal processing on the buffered image data IDATA to generate the second image data IDATA_D, and outputs the second control signal CON_D.

FIG. 3 is a block diagram illustrating an example of the back light unit image processor included in the control circuit of FIG. 2.

Referring to FIG. 3, a back light unit processor 1160 may include an image feature extraction unit 1161, an image classification unit 1163, and a calculation unit 1165.

The image feature extraction unit 1161 extracts image features based on the buffered image data IDATA. For example, the image feature extraction unit 1161 may perform binarization of the buffered image data IDATA to obtain gray scaled image data. The image classification unit 1163 classifies the image data based on the extracted image features EIF. The calculation unit 1165 calculates an image contrast value and a power supply control value based on the classified image data CI to generate the first image data IDATA_B.

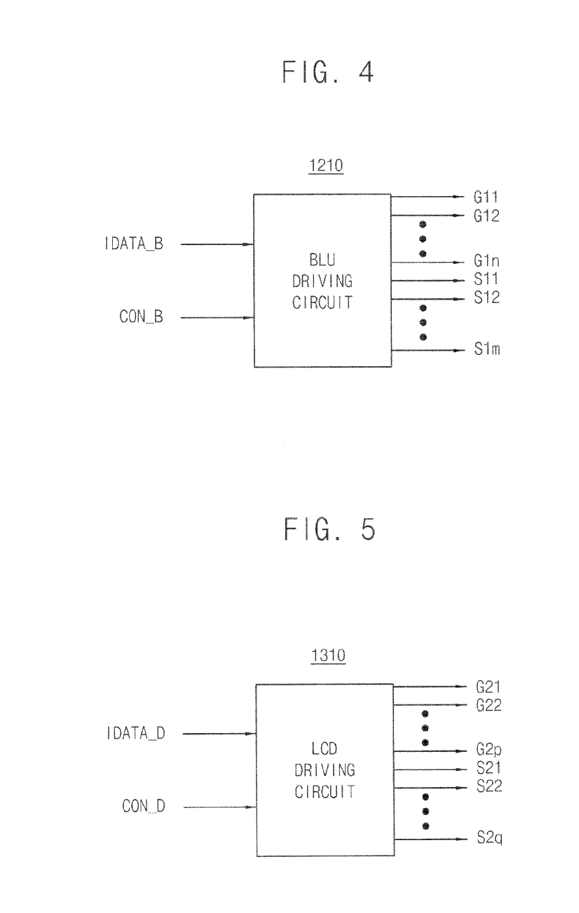

FIG. 4 is a block diagram illustrating an example of the back light unit driving circuit included in the LCD module of FIG. 1.

Referring to FIG. 4, the back light unit driving circuit 1210 generates the first gate control signals G11, G12, . . . , G1n and the first source signals S11, S12, . . . , S1m based on the first image data IDATA_B and the first control signal CON_B. The back light unit driving circuit 1210 drives the flexible back light unit panel 1200 based on the first gate control signals G11, G12, . . . , G1n and the first source signals S11, S12, . . . , S1m.

FIG. 5 is a block diagram illustrating an example of the LCD driving circuit included in the LCD module of FIG. 1.

Referring to FIG. 5, the LCD driving circuit 1310 generates the second gate control signals G21, G22, . . . , G2p and the second source signals S21, S22, . . . , S2q based on the second image data IDATA_D and the second control signal CON_D. The LCD driving circuit 1310 drives the LCD panel 1300 based on the second gate control signals G21, G22, . . . , G2p and the second source signals S21, S22, . . . , S2q.

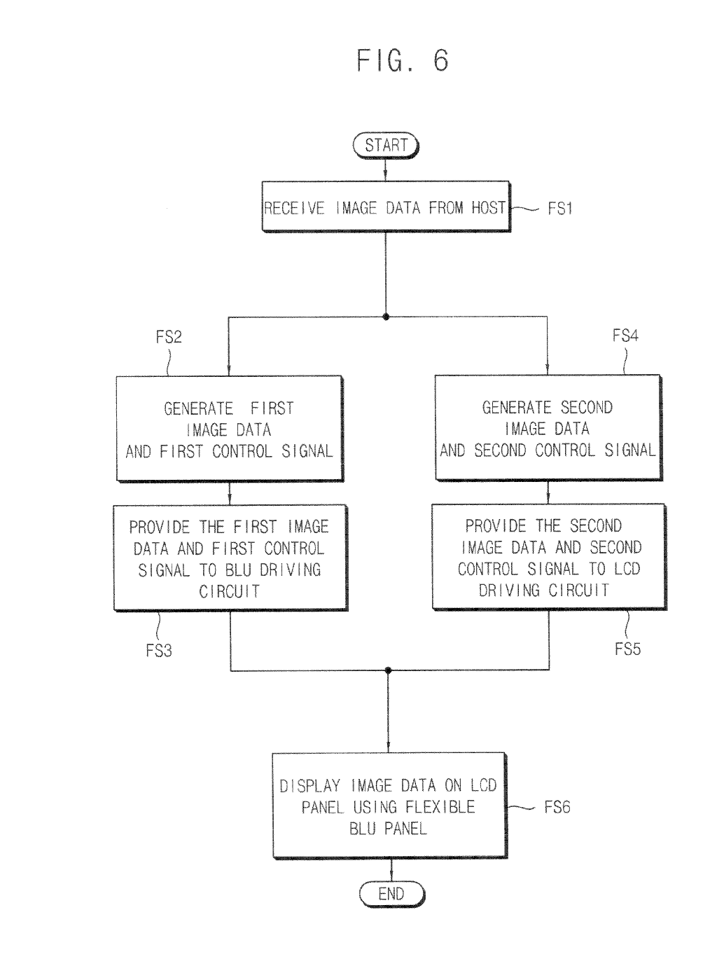

FIG. 6 is a flow chart illustrating a method of driving the LCD module according to some example embodiments.

Referring to FIG. 6, the method of driving the LCD module may include below steps.

The image data is received by a host (Step FS1). The host may be any device that outputs image data, such as a commercial video output device, a digital image output device, or any other device that can output image data electrically.

The first image data is generated by performing feature extraction, classification, and calculation on the received image data (Step FS2). For example, predetermined colors, shades, shapes, or other features may be detected and extracted. The image may be classified using a predetermined classification system including different classifications corresponding to different characteristics. The image contrast value and a power supply control value are calculated based on the image classification.

The first image data and the first control signal are provided to the back light unit driving circuit (Step FS3) to control the lighting of the back light unit.

The second image data is generated by processing the image data (Step FS4).

The second image data and the second control signal are provided to the LCD driving circuit to control operation of the LCD (Step FS5).

The image is displayed on the LCD panel using the flexible back light unit panel (Step FS6).

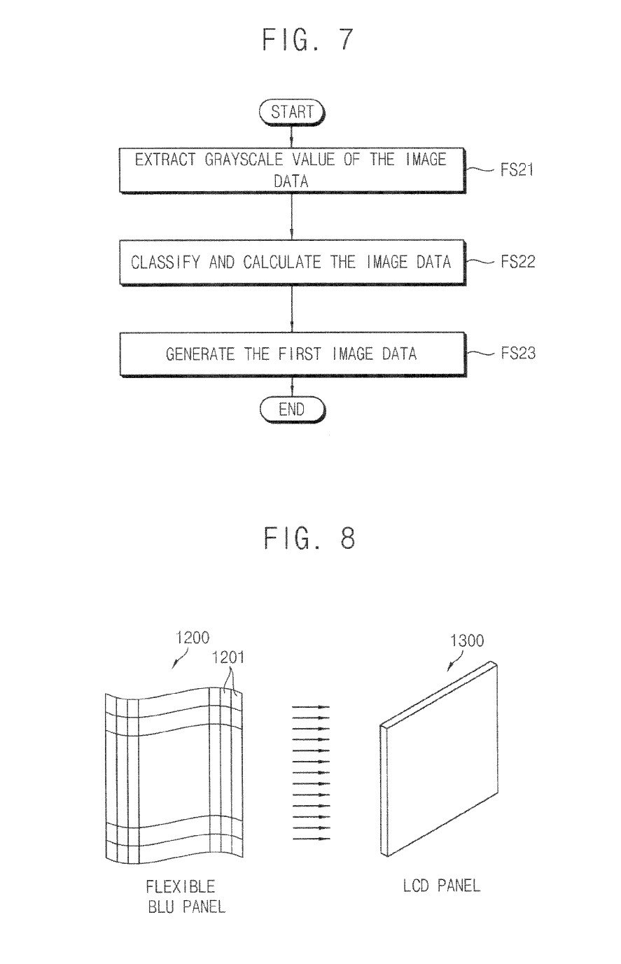

FIG. 7 is a flowchart illustrating an example of generating the first image data (Step FS2) in FIG. 6.

Grayscale values of the image data are extracted (Step FS21), and the image data is classified based on the extracted grayscale values. An image contrast value and a power supply control value are calculated based on the image classification (Step FS22).

The first image data is generated using the image contrast value and the power supply control value (Step FS23).

FIG. 8 illustrates an LCD panel and a flexible back light unit panel having a plurality of planar light sources in the matrix form and the LCD panel.

Referring to FIG. 8, the flexible back light unit panel 1200 has a plurality of planar light sources 1201 that are arranged in a matrix form, and is located behind the LCD panel 1300 to provide backlight to the LCD panel 1300.

The flexible back light unit panel 1200 may be fabricated on plastic substrates so that the flexible back light unit panel 1200 is bendable, and thus the flexible back light unit panel 1200 may be thin.

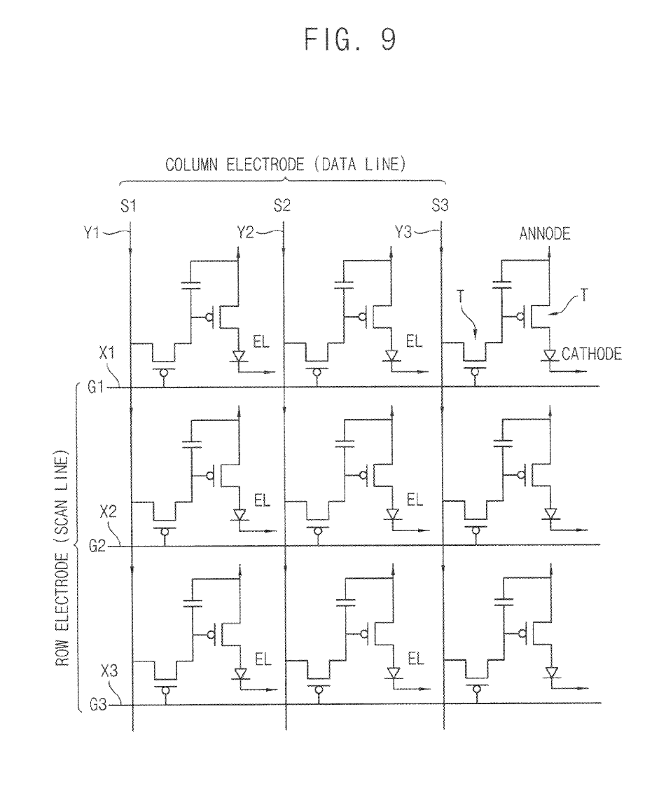

FIG. 9 is a circuit diagram illustrating an example of a cell array of the flexible back light unit panel.

Referring to FIG. 9, a cell array of the flexible back light unit panel may include row electrodes X1, X2 and X3 and column electrodes Y1, Y2 and Y3, which are orthogonal with each other. Unit cell is located at an intersection of the row electrodes and the column electrodes. The unit cell may include a PMOS transistor T, a capacitor C, and a diode EL. The gate control signals G1, G2 and G3 are applied to the row electrodes X1, X2 and X3 and the source signals S1, S2, and S3 are applied to the column electrodes Y1, Y2 and Y3. As such the flexible back light unit panel may be driven in a matrix form using the row electrodes X1, X2 and X3 and column electrodes Y1, Y2 and Y3.

The flexible back light unit panel 1200 may be flexible to a predetermined degree depending on the materials, thickness, and structure of the flexible back light unit panel 1200. For example, if a first row of planar light sources 1201 of the flexible back light unit panel 1200 are adjacent to a second row, the first row may exist on a first plane and the second row may exist on a second plane that is not co-planar with the first plane. In addition, the flexible back light unit panel 1200 may be flexible within a row of planar light sources 1201, so that a first part of the planar light sources 1201 exists on a first plane and a second part of the planar light sources 1201 exists on a second plane that is not co-planar with the first plane. In other words, the flexible back light unit panel 1200 may be bendable between planar light sources 1201 or within the planar light sources 1201. In addition, while the row electrodes X1-X3 and column electrodes Y1-Y3 may be co-planar when the flexible back light unit panel 1200 is in an un-bent state, adjacent row electrodes X1-X3 and adjacent column electrodes Y1-Y3 may exist on different planes when the flexible back light unit panel 1200 is bent relative to the plane of the un-bent back light panel.

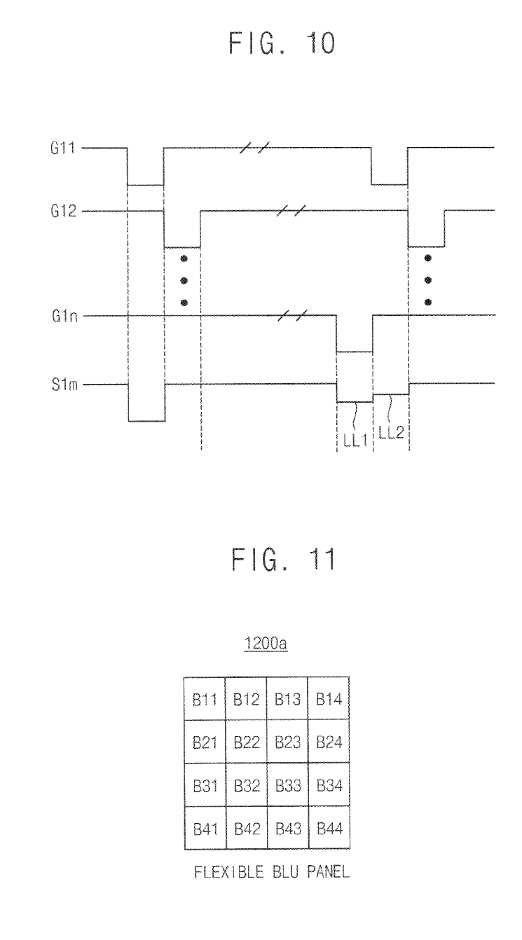

FIG. 10 illustrates waveforms of the control signals applied to the row electrodes X1, X2 and X3 and the column electrodes Y1, Y2 and Y3 of the cell array in FIG. 9.

Referring to FIG. 10, the gate control signals G11, G12, and G1n are sequentially enabled to logic low, and the grayscale value is provided through the source signal S1m and the grayscale value is stored in the capacitor of the corresponding unit cell. The back light unit emits lights based on the stored grayscale value, and thus the LCD panel may perform local dimming operation.

The LCD module including the flexible back light unit panel changes levels LL1 and LL2 of the source signals S1m to represent the grayscale value by using the back light unit driving circuit during the local dimming operation. Because the flexible back light unit panel includes planar light sources in a matrix form to provide backlight based on the source signals, the luminance properties of each individual block may be controlled. Because the planar light sources are used, the LCD module does not require a diffusion sheet, as in the conventional back light unit.

The LCD module including the flexible back light unit panel according to the present general inventive concept uses planar light sources, which may be finely divided into blocks arranged in a matrix form, and the image data displayed on the LCD panel may have high-definition. Because the LCD module including the flexible back light unit panel synchronizes frame frequency and driving frequency of the LCD module, the flicker noise may be reduced and the LCD module may produce a clear and sharp image.

FIG. 11 is a diagram illustrating the flexible back light unit panel divided into a plurality of blocks for the local dimming operation. As illustrated in FIG. 11, the flexible back light unit panel included in the LCD module according to the inventive step may be easily segmented. In FIG. 11, the flexible back light unit panel 1200a is divided into 16 blocks B11, B12, B13, B14, B21, B22, B23, B24, B31, B32, B33, B34, B41, B42, B43, and B44.

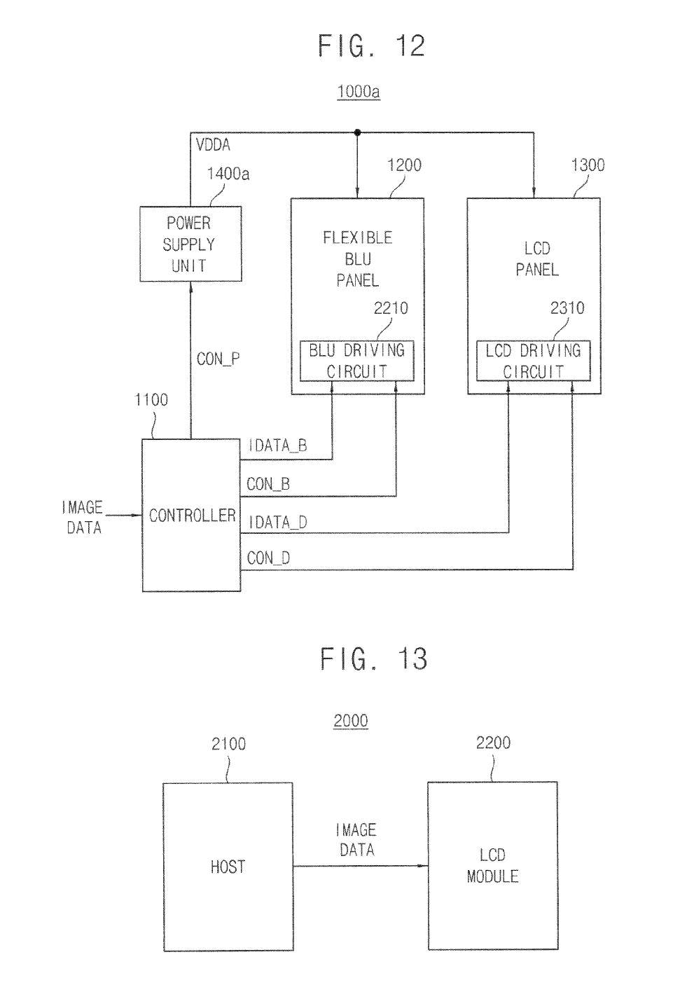

FIG. 12 is a block diagram illustrating an example embodiment of an LCD module according to some example embodiments.

Referring to FIG. 12, the LCD module 1000a may include a control circuit 110, a flexible back light unit panel 1200, an LCD panel 1300, and a power supply unit 1400a.

Compared with the power supply unit 1400 in FIG. 1, the power supply unit 1400a may adjust a power supply voltage VDDA in response to a power control signal CON_P generated by the control circuit 1100. The power control signal CON_P may be generated based on the received image data from outside the LCD module, such as from an external device. The power supply voltage VDDA may vary according to the image data and may be provided to the flexible back light unit 1200 and the LCD panel 1300. As a result, the LCD module may perform a global dimming operation of the entire LCD module as well as a local dimming operation of individual light blocks of the LCD panel.

Because structures and operations of the LCD module 1000a of FIG. 12 are similar to that of the LCD module 1000 of FIG. 1, the detailed description will be omitted.

FIG. 13 is a block diagram illustrating a display system including the LCD module.

Referring to FIG. 13, the display system 2000 may include a host 2100 and the LCD module 2200.

The host 2100 may be a graphic controller or another device including the graphic controller. The LCD module 2200 receives the image data from the host 2100, generates the first image data, the first control signal, the second image data, and the second control signal based on the received image data. The LCD module drives the flexible back light unit based on the first image data and the first control signal, and drives the LCD panel based on the second image data and the second control signal.

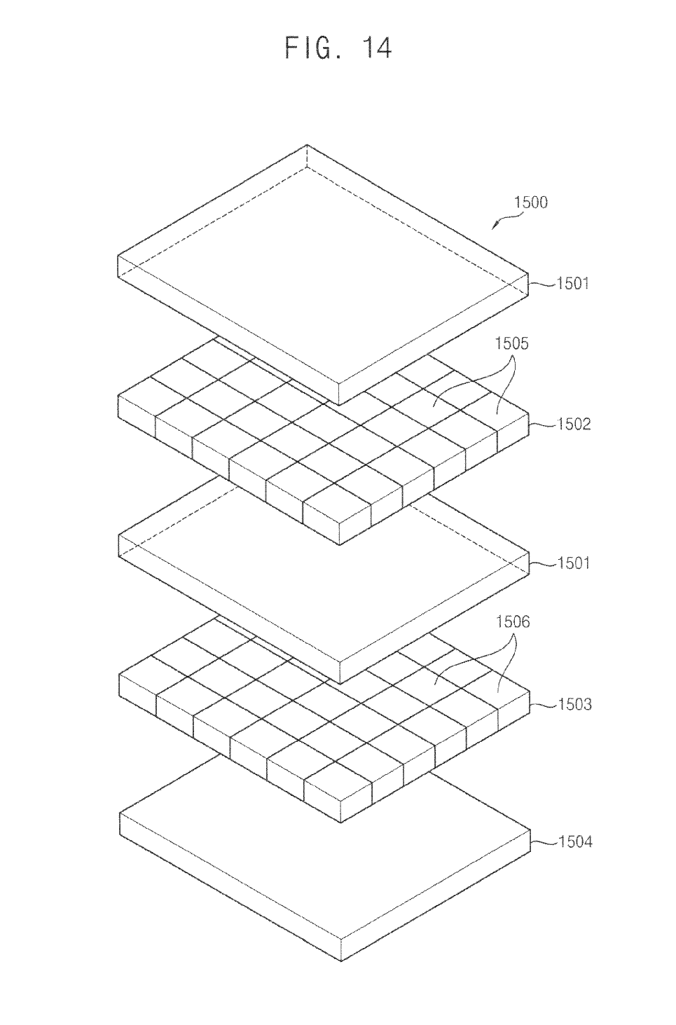

FIG. 14 illustrates an expanded view of layers of an LCD module display 1500. An LCD layer 1502 may include a plurality of liquid cells 1505 arranged in a grid or matrix pattern, and each liquid cell 1505 outputs a predetermined color and/or shade depending on input from control lines (not shown). The LCD layer may be formed between two transparent layers 1501, such as glass layers. One of the transparent layers 1501 may serve as a substrate to form the LCD layer 1502.

A back light layer 1503 may include a plurality of planar light cells 1506 arranged in a grid or matrix pattern. The grid or matrix pattern may correspond to the grid or matrix pattern of the LCD layer 1502. For example, the grid or matrix pattern of the back light layer 1503 may be coarse compared to the grid or matrix pattern of the LCD layer 1502. Each planar light cell 1506 may be activated to emit light by control lines (not shown). The back light layer 1503 may be formed on a substrate 1504, such as a plastic substrate. The substrate 1504 may be flexible and thin to allow the back light layer 1503 to also be flexible.

As mentioned above, the LCD module has a flexible panel having the planar light sources arranged in the matrix form, and thus a diffusing sheet to diffuse a spot light source may not be needed. Therefore, the LCD module may have a simple structure and may have a small size. Because the LCD module includes the flexible back light unit panel having the planar light sources arranged in the matrix form, the LCD module may effectively perform the local dimming operation. The flexible back light unit panel may be fabricated on a plastic substrate, allowing the back light unit panel to be thin.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A liquid crystal display (LCD) module, comprising:
an LCD panel; and
a flexible back light unit panel located adjacent to the LCD panel, the flexible back light unit panel including a plurality of planar light sources arranged in a matrix form to provide backlight to the LCD panel.

2. The LCD module of claim 1, further comprising:
a control circuit to receive image data, and to generate first image data, a first control signal, second image data, and a second control signal based on the received image data.

3. The LCD module of claim 2, further comprising:
a back light unit driving circuit to receive the first image data and first control signal and to generate first gate control signals and first source signals to drive the flexible back light unit panel; and
an LCD driving circuit to receive the second image data and second control signal and to generate second gate control signals and second source signals to drive the LCD panel.

4. The LCD module of claim 3, wherein the back light unit driving circuit and the flexible back light unit panel are embodied as one unit, and the LCD driving circuit and the LCD panel are embodied as one unit, respectively.

5. The LCD module of claim 2, wherein the control circuit comprises:
an interface circuit to receive the image data, to generate a control signal based on the image data, and to buffer the image data;
a storage unit to store the buffered image data, and to output the first control signal and the second control signal based on the control signal from the interface circuit; and
a signal processing unit to receive the buffered image data, the first control signal, and the second control signal, and to generate the first image data, the first control signal, the second image data, and the second control signal based on the buffered image data, the first control signal and the second control signal.

6. The LCD module of claim 5, wherein the storage unit comprises:
a control register to store the control signal, and to output the first control signal and the second control signal based on the control signal; and
a frame buffer to store the buffered image data.

7. The LCD module of claim 5, wherein the signal processing unit comprises:
a back light unit image processor to receive the first control signal and the buffered image data, to perform signal processing on the buffered image data to generate the first image data and to output the first control signal; and
a display image processor to receive the second control signal and the buffered image data, to perform signal processing on the buffered image data to generate the second image data, and to output the second control signal.

8. The LCD module of claim 7, wherein the back light unit image processor comprises:
an image feature extraction unit to extract image features based on the buffered image data;
an image classification unit to classify the image data based on the extracted image features; and
a calculation unit to calculate a contrast value and a power supply control value based on the classified image data to generate the first image data.

9. The LCD module of claim 2, further comprising:
a power supply unit to provide a power supply voltage to the LCD panel and the flexible back light unit panel, and to adjust a magnitude of the power supply voltage based on a power control signal from the control circuit.

10. A display system, comprising:
a host to provide image data; and
an LCD module to receive the image data from the host, to generate first image data, a first control signal, second image data, and a second control signal based on the received image data, to drive a flexible back light unit panel based on the first image data and the first control signal, and to drive an LCD panel based on the second image data and the second control signal.

11. An LCD module, comprising:
an LCD layer; and
a backlight layer adjacent to the LCD layer, the backlight layer comprising a plurality of planar light elements, each planar light element including a substantially planar light-emitting surface to emit light toward the LCD layer,
wherein the substantially planar light-emitting surfaces of the plurality of planar light elements are located along substantially the same flat plane when the backlight layer is in an un-bent state.

12. The LCD module according to claim 11, wherein the LCD layer comprises a plurality of liquid cells arranged in a grid, and
the plurality of planar light elements of the backlight layer are arranged in a grid to correspond to the grid of the LCD layer.

13. The LCD module according to claim 11, wherein the plurality of planar light elements are formed on a flexible plastic substrate.

14. The LCD module according to claim 11, wherein each of the plurality of planar light elements comprises:
at least one first transistor;
at least one capacitor having a first end connected to a drain of the first transistor;
at least a second transistor having a gate connected to the drain of the first transistor and a source connected to a second end of the capacitor; and
at least one diode connected to the drain of the second transistor.

15. The LCD module according to claim 14, wherein the backlight layer further comprises:
a plurality of column electrodes, each column electrode of the plurality of column electrodes connected to a source of the first electrode of a plurality of planar backlight elements arranged in a column; and
a plurality of row electrodes orthogonal to the plurality of column electrodes, each row electrode of the plurality of row electrodes connected to a gate of the first transistor of a plurality of planar backlight elements arranged in a row.

16. The LCD module according to claim 15, further comprising:
a backlight layer driving circuit to transmit control signals to the plurality of column electrodes and the plurality of row electrodes, respectively.

17. The LCD module according to claim 16, wherein the backlight layer driving circuit is located on the backlight layer.

18. The LCD module according to claim 16, further comprising:
an LCD driving circuit to drive the LCD layer; and
a controller to receive an image signal and to output a first image data signal and a first control signal to the backlight unit driver circuit and to output a second image data signal and a second control signal to the LCD driving circuit.

19. The LCD module according to claim 18, wherein the controller comprises:
an interface circuit to receive the image signal and to output an interface circuit control signal and the image signal;
a control register to receive the interface circuit control signal and to output a first control signal to control operation of the backlight layer and a second control signal to control operation of the LCD layer;
a frame memory to buffer the image signal;
a backlight layer image processor to receive the first control signal and the buffered image signal, to process the buffered image signal, and to output first image data and the first control signal to control the backlight layer; and
a display image processor to receive the second control signal and the buffered image signal, to process the buffered image signal, and to output second image data and the second control signal to control the LCD layer.

20. The LCD module according to claim 19, wherein the backlight layer processor comprises:
an image feature extraction unit to receive the buffered image signal, to extract at least one feature from the image signal, and to output an extracted image feature signal;
an image classification unit to receive the extracted image feature signal, to classify the image according to the extracted image feature signal, and to output a classification signal; and
a calculation unit to calculate characteristics of the classification signal and to output the second image data.

21. A display system, comprising:
a host to output an image signal; and
an LCD module to receive and display the image signal, the LCD module comprising:
an LCD layer;
a backlight layer adjacent to the LCD layer, the backlight layer comprising a plurality of planar light elements to diffusely emit light toward the LCD layer; and
a controller to control operation of the LCD layer and the backlight layer,
wherein the controller receives the image signal and controls operation of the LCD layer and the backlight layer according to the received image signal.
